(19) United States
(12) Patent Application Publication
(10) Pub. No.: US 2024/0257400 A1
(43) Pub. Date: Aug. 1, 2024

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: TAKETOSHI KUSAKABE, Kanagawa (JP)

(21) Appl. No.: 18/421,695

(22) Filed: Jan. 24, 2024

(30) Foreign Application Priority Data
Jan. 30, 2023 (JP) 2023-012280

(51) Int. Cl. G06T 7/90; G06T 7/62; G06V 10/56

(52) U.S. Cl. CPC G06T 7/90; G06T 7/62; G06V 10/56; G06T 2207/10024

(57) ABSTRACT

An image forming apparatus acquires image data representing a first image, performs control, in a case where a first area corresponding to a particular color in the first image satisfies a condition regarding a size, to perform color measurement on the first area in the first image printed using the image data, and performs control, in a case where the first area does not satisfy the condition regarding the size, to perform the color measurement on a second image that includes a second area and that is different from the first image, the second area satisfying the condition regarding the size and corresponding to the particular color.

### BACKGROUND

### Field

The present disclosure generally relates to image processing and, more particularly, to a technique for performing color measurement on a print product.

### Description of the Related Art

In a case where a color with the tint that is defined, such as a PANTONE color system, a corporate color, and a Japanese Industrial Standards (JIS) safety color, is expressed in print, color matching is performed so that the color to be expressed becomes to have a desired tint. As a color matching method, known is a method of performing color measurement on an area in which a target color has been printed in a print product output from an image forming apparatus, such as a printer, and comparing tints between a result of the color measurement and a sample, such as a color chip. The print product as a color measurement target includes arranged rectangular images with gradual color variations, which is called a color patch, a color chart, a control strip, and the like. Japanese Patent Application Laid-Open No. 2016-201726 discusses a technique for determining whether a chart having been subjected to color measurement is useable for color management.

However, in Japanese Patent Application Laid-Open No. 2016-201726, a chart dedicated to color verification is to be printed in addition to a print target image, which increases print cost.

### SUMMARY

Thus, the present disclosure is directed to provision of processing to perform color matching of a color to be expressed in print at low cost.

According to some embodiments, an image processing apparatus includes an acquisition unit configured to acquire image data representing a first image, a color measurement control unit configured to perform control, in a case where a first area corresponding to a particular color in the first image satisfies a condition regarding a size, to perform color measurement on the first area in the first image printed using the image data, and perform control, in a case where the first area does not satisfy the condition regarding the size, to perform the color measurement on a second image that includes a second area and that is different from the first image, the second area satisfying the condition regarding the size and corresponding to the particular color.

Further features of the present disclosure will become apparent from the following description of exemplary embodiments with reference to the attached drawings.

### BRIEF DESCRIPTION OF THE DRAWINGS

FIG. 1 is a diagram illustrating an apparatus configuration of an image forming system.

FIG. 2 is a block diagram illustrating a functional configuration of the image forming system.

FIG. 3 is a diagram for illustrating a configuration of image data.

FIG. 4 is a diagram for illustrating a configuration of image data.

FIG. 5 is a diagram for illustrating a configuration of image data.

FIG. 6 is a flowchart illustrating processing executed by an image processing apparatus.

FIG. 7 is a diagram illustrating an example of a user interface.

FIG. 8 is a diagram illustrating an example of a user interface.

FIG. 9 is a diagram illustrating an example of a user interface.

### DESCRIPTION OF THE EMBODIMENTS

Various exemplary embodiments, features, and aspects will be described below with reference to the accompanying drawings. However, the present disclosure is not necessarily limited to the following exemplary embodiments. All combinations of features described in each exemplary embodiment are not necessarily essential to a means for solving issues of the present disclosure.

### <Configuration of Image Forming System>

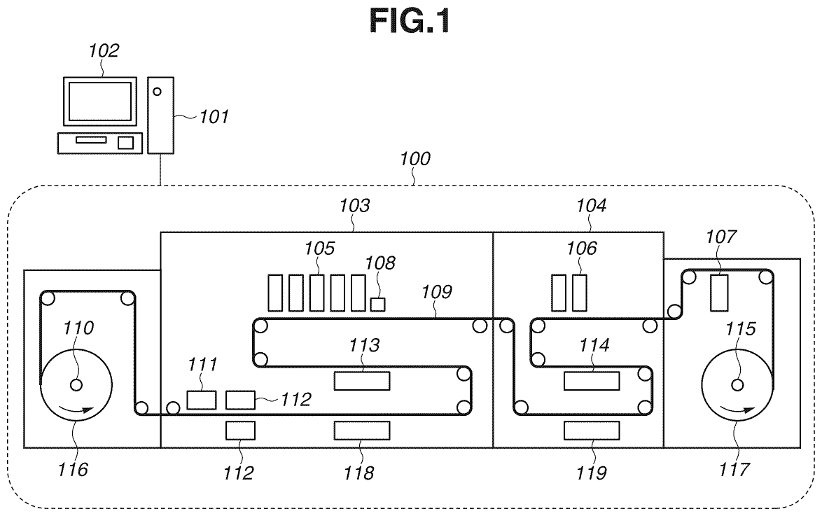

A first exemplary embodiment of the present disclosure will be described. FIG. 1 is a diagram illustrating an example of an apparatus configuration of an image forming system according to the present exemplary embodiment. The image forming system includes an image forming apparatus 100, a control computer 101 for the image forming apparatus 100, and an operation display apparatus 102. The image forming apparatus 100 forms an image in continuous paper (hereinafter referred to as roll paper) 109 on which continuous image is formable. The image forming apparatus 100 according to the present exemplary embodiment includes a basic color print unit 103 that performs print in a basic color, a particular color print unit 104 that performs print in a particular color, a paper feed unit 117 that conveys the roll paper 109, and a paper discharge unit 116 that winds the roll paper 109.

The paper feed unit 117 supplies the roll paper 109 to the image forming apparatus 100. The paper feed unit 117 rotates a paper tube of the roll paper 109 with a rotary shaft 115 serving as the center, and conveys the roll paper 109 wound around the paper tube toward the image forming apparatus 100 at a constant speed via a plurality of rollers (conveyance rollers, paper feed rollers, and the like). The paper discharge unit 116 winds the roll paper 109 conveyed from the image forming apparatus 100 on the paper tube in a roll shape. The roll paper 109 is wound up on the paper tube of a rotary shaft 110 and its roll shape is maintained, for example, as illustrated in FIG. 1. The paper discharge unit 116 winds up, as a print deliverable, the roll paper 109 conveyed to the paper tube on the rotary shaft 110 at a constant speed via a plurality of rollers (conveyance rollers, paper discharge rollers, and the like).

Before start of print, the roll paper 109 passes from the paper feed unit 117 to the paper discharge unit 116.

More specifically, the roll paper 109 is initially set in the paper feed unit 117 and the leading end of the roll paper 109 passes above a skew correction unit 107. Subsequently, the roll paper 109 passes below an image forming unit 106 of the particular color print unit 104. Subsequently, the roll paper 109 passes above a drying unit 114, and thereafter passes above a cooling unit 119. Subsequently, the roll paper 109 is passed below a timing mark detection unit 108 of the basic color print unit 103, below an image forming unit 105, above a drying unit 113, and then above a cooling unit 118.

Subsequently, the roll paper 109 is passed through scanner units 112, below a color measurement unit 111, and the paper discharge unit 116 winds up the conveyed roll paper 109. The roll paper 109 passes through the inside of the image forming apparatus 100, and thereafter an image forming job is input to the control computer 101 for the image forming apparatus 100. After the input of the image forming job, a print start button is pressed in the operation display apparatus 102 to start print.

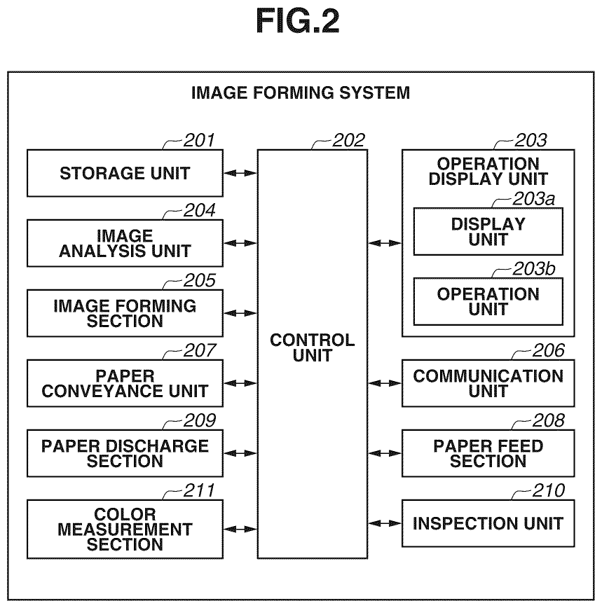

FIG. 2 is a block diagram illustrating an example of a functional configuration of the image forming system according to the present exemplary embodiment. The image forming system includes a storage unit 201, a control unit 202, an operation display unit 203, an image analysis unit 204, an image forming section 205, a communication unit 206, a paper conveyance unit 207, a paper feed section 208, a paper discharge section 209, an inspection unit 210, and a color measurement section 211.

The storage unit 201 includes a non-volatile semiconductor memory (flash memory), a hard disk drive (HDD), a solid state drive (SSD), or the like. Various programs, such as a system program and a processing program, to be executed by the control unit 202, and various data to be used for executing these programs are stored in the storage unit 201.

The control unit 202 includes a central processing unit (CPU), a random access memory (RAM), and the like. The CPU of the control unit 202 loads various programs, such as the system program and the processing program, stored in the storage unit 201 in the RAM, and executes various types of processing in accordance with the loaded program. The control unit 202 is capable of performing image forming processing of executing an image forming job (hereinafter referred to as a job) in response to a user's instruction. Each function constituting the image forming system is controlled based on instructions from the control unit 202.

The operation display unit 203 includes a liquid crystal display (LCD) with a touch panel, and includes a display unit 203a and an operation unit 203b. The display unit 203a displays various types of information on a display screen in accordance with a display control signal input from the control unit 202. The operation unit 203b includes various operation keys, such as a numeric keypad and a start key. The operation unit 203b receives various input operations from the user and outputs operation signals to the control unit 202. Conditions including paper to be used, information about a print speed, the number of sheets to be printed, the number of prints, a length of a print product, a weight of the print product, a diameter of the print product, among other pieces of information are freely settable by the user. The control unit 202 can function as an acquisition unit configured to obtain image data representing one or more images.

The image analysis unit 204 performs analysis processing, rendering processing, and screen processing on print data for which an output instruction is issued, and converts the print data into a format in which printing is performable by the image forming apparatus 100. The image forming section 205 functions as a print control unit that controls print of an image on the roll paper 109 via the image forming units 105 and 106. The communication unit 206 includes a communication control card, such as a local area network (LAN) card. The communication unit 206 transmits and receives various types of data to/from an external apparatus (e.g., a personal computer) connected to a communication network, such as a LAN and a wide area network (WAN).

The paper conveyance unit 207 controls a conveyance mechanism for conveying the roll paper 109 in the image forming apparatus 100. The paper conveyance unit 207 uses a plurality of rollers to convey the roll paper 109 conveyed from the paper feed unit 117 to the paper discharge unit 116 via the image forming units 105 and 106. The paper feed section 208 controls the paper feed unit 117. The paper discharge section 209 controls the paper discharge unit 116. The inspection unit 210 controls the scanner units 112 to check whether the image has been successfully printed on print paper without an ejection failure. The inspection unit 210 reads a pattern for inspecting an ejection failure printed by the image forming units 105 and 106 with the scanner units 112 to check for an ejection failure in a printed image. If the inspection unit 210 detects an ejection failure, the inspection unit 210 stops the image forming apparatus 100. A method of inspecting an ejection failure is not limited to the foregoing example, and a method of directly reading the printed image with a camera, a scanner, or the like to inspect the printed image, a method of monitoring a state of ejection from a nozzle, or the like may be used. The control unit 202 can function as an acquisition unit configured to acquire image data from one or more images from the roll paper 109.

The color measurement section 211 functions as a color measurement control unit that controls the color measurement unit 111, and performs color measurement on an area indicated by the control unit 202 to acquire color information from the roll paper 109. The color measurement unit 111 is movable in a conveyance direction of the roll paper 109 and a direction orthogonal to the conveyance direction of the roll paper 109, and capable of performing color measurement on not only an image on the roll paper 109 but also a freely-selected area. A condition of an area that is subjectable to color measurement by the color measurement unit 111 in the present exemplary embodiment is that the area has a square shape of 1 cm in length by 1 cm in width, but the size and shape of the area is not limited thereto. For example, the area may have a circular shape having a radius of 1 cm. The condition may be related only to the size, or may be related only to the shape. The condition to be used may be a condition that is determined for each colorimeter used as the color measurement unit 111, or may be set by the user.

In the present exemplary embodiment, the image forming apparatus 100 functions as an image processing apparatus including the control unit 202 and the image analysis unit 204, but the control computer 101 connected to the image forming apparatus 100 may function as the image processing apparatus. The functional configuration of the image forming system may be implemented by one apparatus, or may be implemented by a plurality of apparatuses.

### <Operations of Image Forming System>

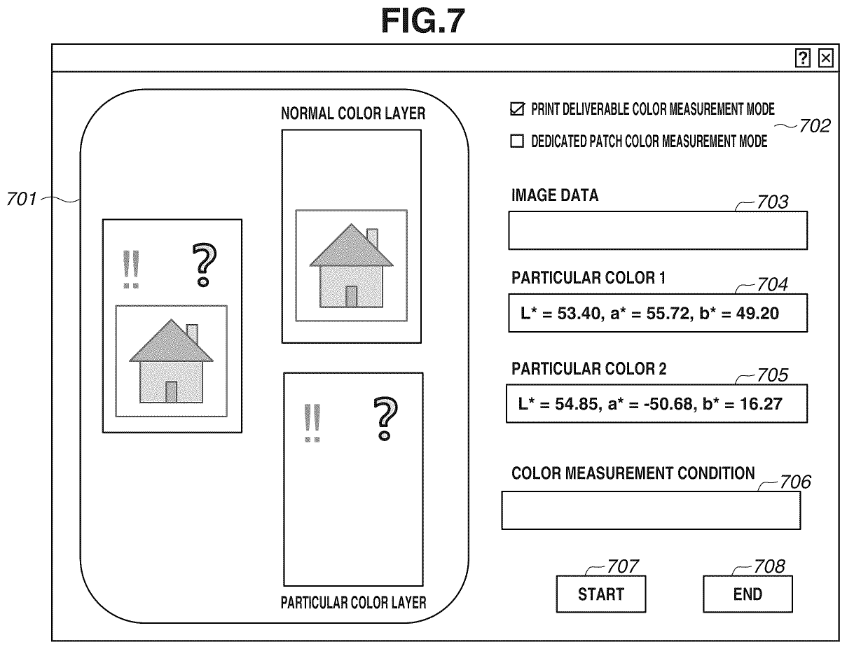

A description is provided of operations of the image forming system in forming an image on the roll paper 109. Initially, the user inputs a job. The control computer 101, the external apparatus, and/or the like is used to create image data of the job and make print settings of the job, and these pieces of information are transmitted to the image forming system via the communication network. FIG. 7 illustrates an example of a user interface for the user to select image data. An image represented by image data selected in an image data selection area 703 is displayed in an image display area 701. A normal color layer and a particular color layer that are included in the image data are separately displayed (layer structure of the image data will be described below). A mode selection area 702 is an area for selecting a color measurement mode from a print deliverable color measurement mode and a dedicated patch color measurement mode. The print deliverable color measurement mode is used for performing processing according to the present exemplary embodiment, which will be described below. The dedicated patch color measurement mode is used for performing print of a dedicated patch and color measurement from the beginning without performing the processing according to the present exemplary embodiment, which will be described below. Particular color display areas 704 and 705 are areas display color information for each particular color included in the particular color layer. A color measurement condition entry area 706 is used for entering the condition of the area that is subjectable to color measurement by the color measurement unit 111. A start button 707 is pressed to start processing. An end button 708 is pressed to end processing. Subsequently, the control unit 202 of the image forming system receives the image data of the job transmitted from the external apparatus or the like, and a job ticket including print setting information regarding the job and information about the number of rolls to be delivered. With this operation, the input of the job is completed. The input job is analyzed by the image analysis unit 204.

More specifically, the image analysis unit 204 extracts information about the job ticket, and extracts pixel data from the image data. The image analysis unit 204 causes the image forming units 105 and 106 to break down color information at each pixel position into printable ink-colors so as to obtain a print product that reflects print settings. The pixel data specifies whether a pixel is a basic color pixel or a particular color pixel, where the basic color pixel is defined in a cyan, magenta, yellow, and black (CMYK) color space or a red, green, and blue (RGB) color space while the particular color requires strict color reproduction, such as a PANTONE color system and a corporate color. There is a case where the particular color pixel includes a white pixel that defines only white, a black pixel that defines only black, and a functional pixel that defines transparency. In the present exemplary embodiment, a description is provided of an example of printing an image including a basic color area that indicates a natural image and a particular color area that indicates a pictogram using a Japanese Industrial Standards (JIS) safety color (JIS Z9103).

When print of the input job is started, the roll paper 109 is conveyed through the path as described in conjunction with FIG. 1, and the control unit 202 prints a timing mark and a background using the image forming unit 106 via the image forming section 205. With the conveyance of the roll paper 109, the timing mark and the background reach the timing mark detection unit 108 via the drying unit 114 and the cooling unit 119. The control unit 202 determines a timing to start print based on a timing at which the timing mark detection unit 108 detects the printed timing mark and uses the image forming unit 105 to perform print. When the roll paper 109 reaches the scanner units 112, the inspection unit 210 determines whether there is an ejection failure. When the roll paper 109 reaches the color measurement unit 111, the color measurement section 211 performs color measurement on an area indicated by the control unit 202 on the roll paper 109. Finally, the roll paper 109 is conveyed through the path as described in conjunction with FIG. 1, and is wound up by the paper discharge unit 116.

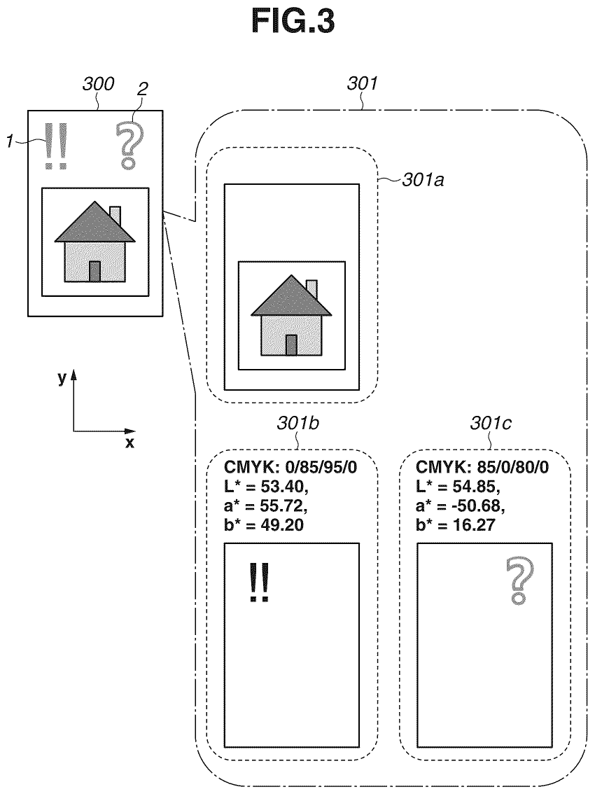

FIG. 3 is a diagram illustrating a configuration of an image 300 represented by first image data of the input job. A layer structure of image data constituting the image 300 is illustrated as a layer structure 301. The image 300 includes a natural image of a house arranged in a central lower portion of the image 300, a pictogram 1 arranged on the upper left of the image 300, and a pictogram 2 arranged on the upper right of the image 300. The layer structure 301 includes a normal color layer 301a forming the natural image, a particular color layer 301b forming the pictogram 1, and a particular color layer 301c forming the pictogram 2. The position of each pixel constituting each image is determined based on two-dimensional coordinates with x- and y-axes. In the two-dimensional coordinates, a lower left corner indicated by a solid line representing an outer frame of each structure of the layers 301a, 301b, and 301c serves as an origin, and the layers 301a, 301b, and 301c are superimposed on each other to implement the image 300. An actual position of an image to be formed on the roll paper 109 is calculated based on a logical position of each pixel determined using the two-dimensional coordinates with the x- and y-axes and based on the print settings. The image forming section 205 identifies an image forming position and the color measurement section 211 identifies a color measurement position based on the calculated coordinates. The normal color layer 301a is constituted by using various types of CMYK values. The particular color layer 301b includes JIS red expressed by C/M/Y/K=0/85/95/0 with a target of implementing L*=53.40, and a*=55.72, b*=49.20. The particular color layer 301c includes JIS green expressed by C/M/Y/K=85/0/80/0 with a target of implementing L*=54.85, and a*=−50.68, and b*=16.27.

The particular color layer 301b includes a high proportion of JIS red, and secures a square shape of 1 cm in length by 1 cm in width, which is the condition of the area that is subjectable to color measurement by the color measurement unit 111. The particular color layer 301c uses JIS green, but includes a large number of thin lines, so that the particular color layer 301c is data that cannot secure the square shape of 1 cm in length by 1 cm in width, which is the condition of the area that is subjectable to color measurement by the color measurement unit 111. The image analysis unit 204 analyzes the job ticket and the image data, thus acquiring information about the layer structure 301 from the image 300 to identify an area on the roll paper 109 and a color on/with which an image is to be formed.

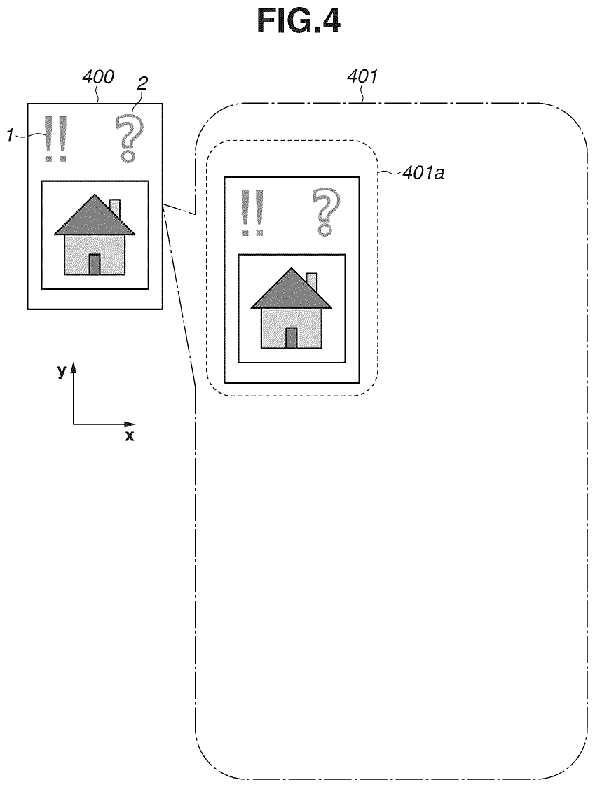

FIG. 4 is a diagram illustrating a configuration of an image 400 represented by second image data of the input job. A layer structure of image data constituting the image 400 is illustrated as a layer structure 401. The image 400 includes a natural image of a house arranged in a central lower portion of the image 400, a pictogram 1 arranged on the upper left of the image 400, and a pictogram 2 arranged on the upper right of the image 400. An outer appearance of the image 400 is similar to that of the image 300, but is different in tints that constituting the pictograms 1 and 2. The layer structure 401 includes a normal color layer 401a forming the natural image. The normal color layer 401a is constituted with various CMYK values. An accurate position of each pixel is determined with the two-dimensional coordinates with the x- and y-axes, and the image forming section 205 identifies an image forming position and the color measurement section 211 identifies a color measurement position. The image analysis unit 204 analyzes the job ticket and the image data, thus acquiring information about the layer structure 401 from the image 400 to identify an area on the roll paper 109 and a color on/with which an image is to be formed.

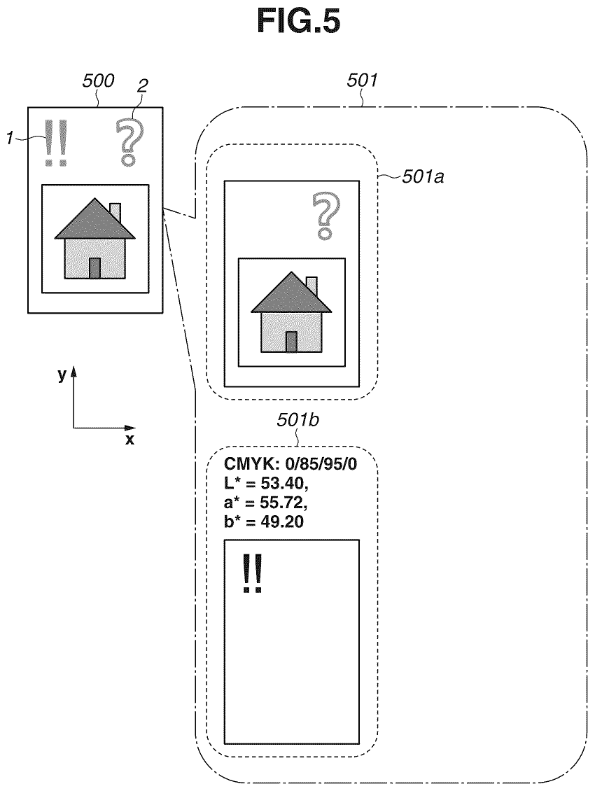

FIG. 5 is a diagram illustrating a configuration of an image 500 represented by third image data of the input job. A layer structure of image data constituting the image 500 is illustrated as a layer structure 501. The image 500 includes a natural image of a house arranged in a central lower portion of the image 500, a pictogram 1 arranged on the upper left of the image 500, and a pictogram 2 arranged on the upper right of the image 300. An outer appearance of the image 500 is similar to that of the image 300, but is different in tints that constituting the pictogram 2.

The layer structure 501 includes a normal color layer 501a forming the natural image and the pictogram 2, and a particular color layer 501b forming the pictogram 1. The normal color layer 501a is constituted with various CMYK values. The particular color layer 501b has a configuration similar to that of the particular color layer 301b. An accurate position of each pixel is determined with the two-dimensional coordinates with the x- and y-axes, and the image forming section 205 identifies an image forming position and the color measurement section 211 identifies a color measurement position. The image analysis unit 204 analyzes the job ticket and the image data, thus acquiring information about the layer structure 501 from the image 500 to identify an area on the roll paper 109 and a color on/with which an image is to be formed.

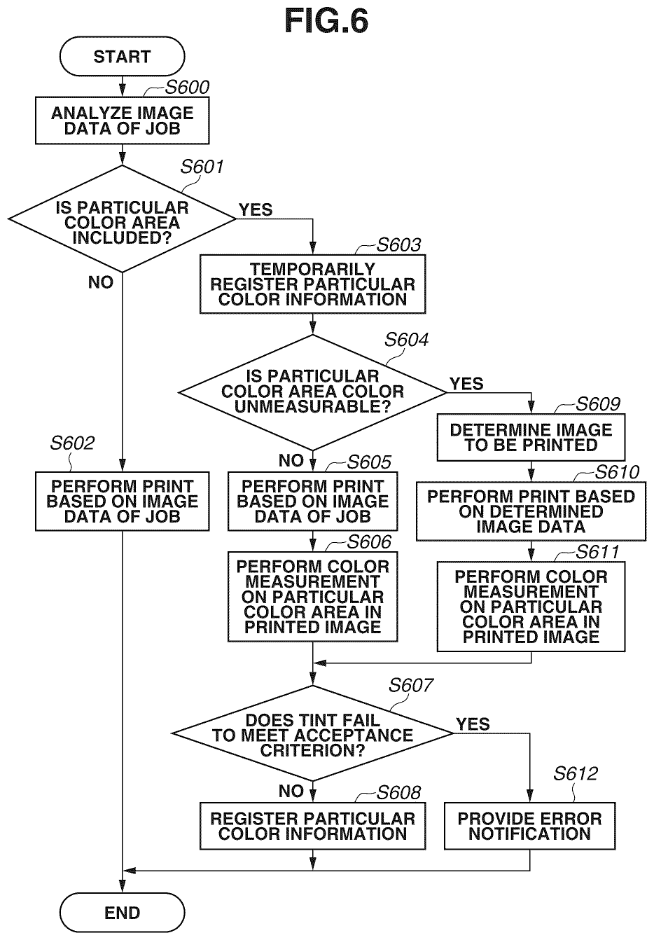

FIG. 6 is a flowchart illustrating processing of registering a particular color profile. When the control computer 101 receives the job, the operations in step S600 and the subsequent steps are executed. The processing is executed mainly via the storage unit 201, the image analysis unit 204, the image forming section 205, and the color measurement section 211 based on instructions from the control unit 202. The image forming apparatus 100 according to the present exemplary embodiment functions as an image processing apparatus that uses the control unit 202 to perform processing of registering the particular color profile, but another computer connected to the image forming apparatus 100 may include the control unit 202 and function as the image processing apparatus.

In step S600, the image analysis unit 204 analyzes data of the job. More specifically, the image analysis unit 204 acquires information regarding a layer included in the image data, and the processing proceeds to step S601. For example, in analyzing the image 300, the image analysis unit 204 acquires the normal color layer 301a, the particular color layer 301b, and the particular color layer 301c. Similarly, in analyzing the image 400, the image analysis unit 204 acquires the normal color layer 401a. In analyzing the image 500, the image analysis unit 204 acquires the normal color layer 501a and the particular color layer 501b.

In step S601, the control unit 202 determines whether the particular color area is included in the job based on a result of analysis performed by the image analysis unit 204. If the particular color layer is included (YES in step S601), the processing proceeds to step S603. If the particular color layer is not included (NO in step S601), the processing proceeds to step S602. For example, for the image 400, the control unit 202 determines that the particular color layer is not included. For the image 300 and the image 500, the control unit 202 determines that the particular color layer is included.

In step S602, the image forming section 205 performs print based on image data of the job. Since only the normal color layer 501a is included in the image 500, the image forming section 205 prints the image 500 and ends the processing. In step S603, the control unit 202 stores acquired information about the particular color area as the particular color profile in the storage unit 201, and temporarily registers the particular color profile as particular color information. For example, for the image 300, the control unit 202 stores related information regarding the particular color layers 301b and 301c. For the image 500, the control unit 202 stores related information regarding the particular color layer 501b. The control unit 202 temporarily registers C/M/Y/K=0/85/95/0 as a particular color profile of JIS red, and C/M/Y/K=85/0/80/0 as a particular color profile of JIS green.

In step S604, the control unit 202 refers to particular color layer information stored in the storage unit 201 to determine whether the particular color area is color-unmeasurable with the color measurement section 211. If the particular color area is color-unmeasurable with the color measurement section 211 (YES in step S604), the processing proceeds to step S609. If the particular color area is color-measurable with the color measurement section 211 (NO in step S604), the processing proceeds to step S605. For example, for the image 300, the particular color layer 301b is color-measurable but the particular color layer 301c is color-unmeasurable, so that the control unit 202 determines that the particular color area is color-unmeasurable. For the image 500, the particular color layer 501b, which is the only particular color area, is color-measurable, so that the control unit 202 determines that the particular color area is color-measurable.

In step S605, the image forming section 205 performs print based on image data of the job. The image forming section 205 prints the normal color layer 301a using various colors, and prints the particular color layer 301b using temporarily registered “JIS red”. In step S606, the color measurement section 211 performs color measurement on an image printed on the roll paper 109 based on the position of the particular color area identified by the image analysis unit 204.

In step S607, the control unit 202 determines whether a tint achieves an acceptance criterion based on a result of color measurement performed by the color measurement section 211 and the particular color information temporarily registered in the storage unit 201 as the particular color profile. If the tint fails to achieve the acceptance criterion (YES in step S607), the processing proceeds to step S612. If the tint reaches the acceptance criterion (NO in step S607), the processing proceeds to step S608. For example, for the image 500, if a result of color measurement performed on a print result of printing an area corresponding to the particular color layer 501b matches L*=53.40, a*=55.72, and b*=49.20, which is the target of JIS red, the control unit 202 determines that the tint is accepted. The acceptance criterion can have a range. For example, the control unit 202 may determine that the tint is accepted if a color difference (ΔE) defined in Commission Internationale de l'Eclairage (CIE) 1976 falls within a range of 1.0. The determination is made for each target particular color. A target value for JIS green is L*=54.85, and a*=−50.68, and b*=16.27 as described in conjunction with the particular color layer 301c.

In step S608, the control unit 202 formally registers the particular color profile which has been temporarily registered in the storage unit 201. In the job that designates the particular color profile, print is performable with a tint as intended. Thus, the control unit 202 completes the registration processing as success. The control unit 202 may notify the user of a result of registration of the particular color profile via the display unit 203a, and/or acquire a final determination about registration from the user via the operation unit 203b.

In step S609, the control unit 202 determines an image to be printed. Since the image 300 includes the particular color layer 301c, which uses JIS green and has been determined in step S604 to be color-unmeasurable, two images of the image 300 and an image for color measurement for JIS green serve as a print target. In step S610, the image forming section 205 performs print based on image data of the print target. As determined in step S609, the image forming section 205 prints the image 300 and the image for color measurement for JIS green. The image 300 performs print using a normal color and two types of particular colors as indicated by the layer structure 301.

The image for color measurement is an image in which a rectangle in a criterion color (JIS green in the present exemplary embodiment) is arranged at the center of the roll paper 109. The shape and size of the rectangle are those of a square with 1 cm in length by 1 cm in width, which is color-measurable by the color measurement unit 111. Thus, the control unit 202 is able to acquire a result of color measurement performed on the image for color measurement via the color measurement section 211.

In step S611, the color measurement section 211 performs color measurement on an image printed on the roll paper 109 based on the position of the particular color area identified by the image analysis unit 204. When the color measurement is completed, the processing proceeds to step S607.

In step S612, the control unit 202 notifies the user of failure of registration of the particular color profile via the display unit 203a. Thus, the control unit 202 completes the registration processing as failure. The error notification allows the user to perform color matching processing through a conventional method.

The control unit 202 can function as an acquisition unit configured to acquire image data representing a first image. The color measurement section 211 can be configured to perform control, in a case where a first area corresponding to a particular color in the first image satisfies a condition regarding a size, to perform color measurement on the first area in the first image printed using the image data. The color measurement section 211 is also configured to perform control, in a case where the first area does not satisfy the condition regarding the size, to perform the color measurement on a second image that includes a second area and that is different from the first image, the second area satisfying the condition regarding the size and corresponding to the particular color.

The color measurement section 211 can be configured to perform control, in a case where the first area has a size that satisfies the condition regarding the size for the color measurement, to perform the color measurement on the first area, and perform control, in a case where the first area has a size that does not satisfy the condition regarding the size for the color measurement, to perform the color measurement on the second area.

The color measurement section 211 can function as a determination unit configured to determine whether the first area satisfies the condition regarding the size for the color measurement, based on the image data, wherein the color measurement control unit is configured to perform control, in a case where the determination unit determines that the first area has the size that satisfies the condition regarding the size for the color measurement, to perform the color measurement on the first area, and perform control, in a case where the determination unit determines that the first area has a size that does not satisfy the condition regarding the size for the color measurement, to perform the color measurement on the second area. The color measurement section 211 can function as an evaluation unit configured to evaluate a result of the color measurement performed on the first area. The evaluation unit can be configured to evaluate the result of the color measurement, based on whether the result of the color measurement falls within a value of a criterion color, based on a user's instruction, or based on other reasons. The color measurement section 211 can function as registration unit configured to register a color profile, based on a result of the color measurement. The color profile can be registered based on whether the result of the color measurement falls within a value of a criterion color, based on a user's instruction, based on a result of the color measurement, or based on other reasons.

As described above, the image processing apparatus according to the present exemplary embodiment extracts an area corresponding to a particular color in an image represented by image data, and determines whether the extracted area satisfies at least one of a condition regarding a size or a condition regarding a shape. In a case where it is determined that the extracted area satisfies the condition, the image processing apparatus performs control to perform color measurement on the extracted area in the printed image using the image data, and evaluates a result of color measurement on the extracted area. This makes it possible to perform color matching of a color to be expressed in print at low cost.

A second exemplary embodiment of the present disclosure will be described below. While the control unit 202 determines the acceptability of the tint obtained as a result of color measurement is acceptable in step S607 in the first exemplary embodiment, the control unit 202 performs display and receives a user operation to prompt the user to determine the acceptability in the present exemplary embodiment. A configuration of the image processing system according to the present exemplary embodiment is equivalent to that in the first exemplary embodiment, and thus a description thereof is omitted. Parts different between the present exemplary embodiment and the first exemplary embodiment are mainly described below. In the following description, constituent elements that are similar to those of the first exemplary embodiment are denoted by the same reference sign.

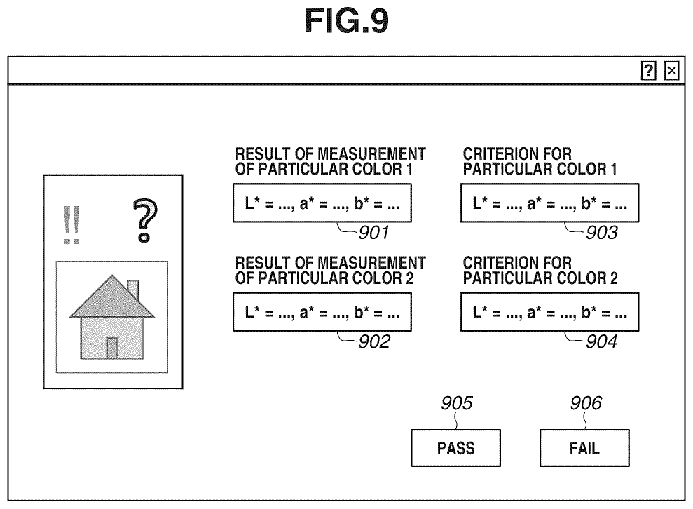

FIG. 6 is a flowchart illustrating processing of registering the particular color profile. The operation in step S607 is different from that in the first exemplary embodiment, and thus is mainly described. In step S607, the control unit 202 notifies the user of a result of color measurement performed by the color measurement section 211 via the display unit 203a. The control unit 202 acquires a result of determination made by the user via the operation unit 203b, and applies the result to subsequent processing. FIG. 9 illustrates an example of a user interface for notifying the user of a result of color measurement and acquiring a result of determination made by the user. The result of color measurement is displayed on a particular color-by-particular color basis in each of color measurement result display areas 901 and 902. A value of a criterion color is displayed on a particular color-by-particular color basis in each of criterion display areas 903 and 904. A “PASS” button 905 is a button to cause processing to proceed to step S608 when being pressed. A “FAIL” button 906 is a button to cause processing to proceed to step S612 when being pressed. This makes it possible to perform the processing of registering the particular color profile based on the user's determination of the acceptability.

As described above, it is possible to analyze a data configuration of a print deliverable in the image forming apparatus, identify a particular color, and perform color measurement on the particular color area in the print deliverable. With this configuration, it is possible to reduce the number of user's work processes, such as print of a dedicated image for color measurement and search for a color measurement area from a print result to perform color measurement. Furthermore, in a case where particular color matching is completed without print of a dedicated print deliverable, it is possible to reduce an amount of paper for printing dedicated patches and a consumption amount of ink.

In the above-mentioned exemplary embodiments, assume that the image forming apparatus 100 is an inkjet printer using ink as a recording material. However, an image forming method is not limited to an inkjet method. For example, the image forming apparatus 100 may be a printer that performs print in an electrophotography method.

In the above-mentioned exemplary embodiments, the image forming apparatus 100 is the apparatus that forms an image on roll paper, but may be an apparatus that forms an image in cut paper.

In the above-mentioned exemplary embodiments, a pixel value of an image is expressed by a CMYK value, but may be expressed by another value, such as an RGB value.

In the above-mentioned exemplary embodiments, color measurement is performed on an area corresponding to a color defined by a standard, such as the JIS standard, as the particular color area in a print deliverable, but may be performed on an area in a metallic color, a fluorescent color, and the like as the particular color area.

In the above-mentioned exemplary embodiments, the mode of performing color measurement on the dedicated image printed for color measurement and the mode of performing the processing according to the above-mentioned exemplary embodiments to perform color measurement on the print deliverable is switchable based on the user's instruction, but a mode may be preliminarily fixed.

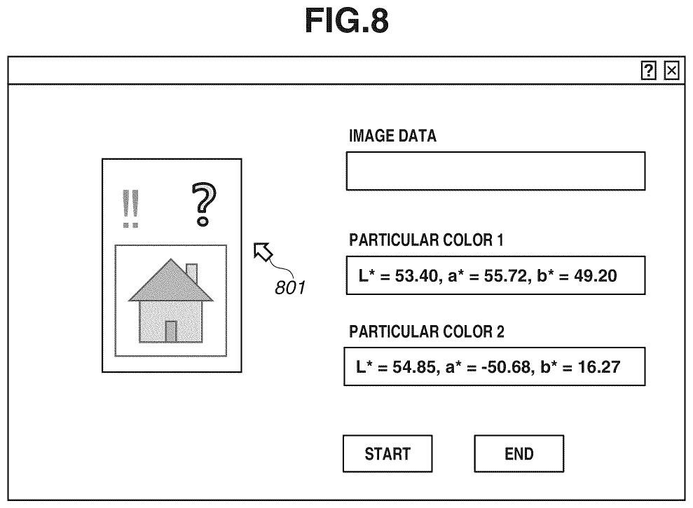

In the above-mentioned exemplary embodiments, image data having the layer structure is used, but image data without the layer structure may be used. For example, the particular color area may be identified based on the user's instruction. FIG. 8 illustrates an example of a user interface for identifying the particular color area. An instruction object 801 is used to designate the particular color area by being operated by the user. A method of designating the particular color area may be a method of designating a range or may be a method of designating coordinates. The particular color area may be identified by designation of a value of a color and analysis of image data based on the designated value. This makes it possible to perform the processing according to the above-mentioned exemplary embodiments even in a case where image data does not have the layer structure.

According to the present disclosure, it is possible to perform color matching of a color to be expressed in print at low cost.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors, circuitry, or combinations thereof (e.g., central processing unit (CPU), micro processing unit (MPU), or the like), and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-012280, filed Jan. 30, 2023, which is hereby incorporated by reference herein in its entirety.

1. An image processing apparatus, comprising:
an acquisition unit configured to acquire image data representing a first image;
a color measurement control unit configured to:
perform control, in a case where a first area corresponding to a particular color in the first image satisfies a condition regarding a size, to perform color measurement on the first area in the first image printed using the image data; and
perform control, in a case where the first area does not satisfy the condition regarding the size, to perform the color measurement on a second image that includes a second area and that is different from the first image, the second area satisfying the condition regarding the size and corresponding to the particular color.

2. The image processing apparatus according to claim 1, wherein the color measurement control unit is configured to:
perform control, in a case where the first area has a size that satisfies the condition regarding the size for the color measurement, to perform the color measurement on the first area, and
perform control, in a case where the first area has a size that does not satisfy the condition regarding the size for the color measurement, to perform the color measurement on the second area.

3. The image processing apparatus according to claim 1, further comprising a determination unit configured to determine whether the first area has a size that satisfies the condition regarding the size for the color measurement, based on the image data,
wherein the color measurement control unit is configured to:
perform control, in a case where the determination unit determines that the first area has the size that satisfies the condition regarding the size for the color measurement, to perform the color measurement on the first area, and
perform control, in a case where the determination unit determines that the first area has a size that does not satisfy the condition regarding the size for the color measurement, to perform the color measurement on the second area.

4. The image processing apparatus according to claim 1, further comprising an evaluation unit configured to evaluate a result of the color measurement performed on the first area.

5. The image processing apparatus according to claim 4, wherein the evaluation unit is configured to evaluate the result of the color measurement, based on whether the result of the color measurement falls within a value of a criterion color.

6. The image processing apparatus according to claim 4, wherein the evaluation unit is configured to evaluate the result of the color measurement, based on a user's instruction.

7. The image processing apparatus according to claim 1, further comprising a registration unit configured to register a color profile, based on a result of the color measurement.

8. The image processing apparatus according to claim 1, wherein the image data includes a plurality of layers including a layer corresponding to the particular color.

9. The image processing apparatus according to claim 1, wherein the image data enables identification of a color and position of the first area.

10. The image processing apparatus according to claim 1, wherein the particular color is a color defined by a standard.

11. The image processing apparatus according to claim 1, wherein the particular color is a metallic color or a fluorescent color.

12. An image processing method, comprising:
acquiring image data representing a first image;
performing control, in a case where a first area corresponding to a particular color in the first image satisfies a condition regarding a size, to perform color measurement on the first area in the first image printed using the image data; and
performing control, in a case where the first area does not satisfy the condition regarding the size, to perform the color measurement on a second image that includes a second area and that is different from the first image, the second area satisfying the condition regarding the size and corresponding to the particular color.

13. A non-transitory computer-readable storage medium storing instructions that, when executed by a computer, cause the computer to perform an information processing method, the method comprising:
acquiring image data representing a first image;
performing control, in a case where a first area corresponding to a particular color in the first image satisfies a condition regarding a size, to perform color measurement on the first area in the first image printed using the image data; and
performing control, in a case where the first area does not satisfy the condition regarding the size, to perform the color measurement on a second image that includes a second area and that is different from the first image, the second area satisfying the condition regarding the size and corresponding to the particular color.
